(19) United States
(12) Patent Application Publication
(10) Pub. No.: US 2002/0049859 A1
(43) Pub. Date: Apr. 25, 2002

(54) Clustered computer system and a method of forming and controlling the clustered computer system

(76) Inventors: William Bruckert, Austin, TX (US); Marcelo M. de Azevedo, Round Rock, TX (US); Robert L. Jardine, Cupertino, CA (US); Mark H. Johnson, Los Gatos, CA (US); Thomas G. Magorka, San Jose, CA (US); Jonathan R. Marcus, San Jose, CA (US); William Bunton, Pflugerville, TX (US); Jeffrey A. Boyd, Leander, TX (US); Jim Klecka, Georgetown, TX (US); Carlo Michael Christensen, San Jose, CA (US)

Correspondence Address: OPPENHEIMER WOLFF & DONNELLY, P. O. BOX 10356, PALO ALTO, CA, 94303, US

(21) Appl. No.: 09/935,440

(22) Filed: Aug. 22, 2001

Related U.S. Application Data
(60) Provisional application No. 60/227,899, filed on Aug. 25, 2000.

(51) Int. Cl. G06F 15/16

(52) U.S. Cl. 709/246

(57) ABSTRACT

A scalable clustered system includes a global fabric, and two or more cluster nodes interconnected via the global fabric. Each cluster node includes a node naming agent (NNA), a local fabric and one or more end nodes interconnected via the local fabric. The NNA is configured as a fully symmetrical translation device interposed between the local fabric and the global fabric. The NNA provides support for scaled clustering by transforming a local/global cluster address into a corresponding global/local cluster address for each packet in an outbound/inbound path. As embodied and broadly described herein, the invention relates also to a method including steps for scaling the clustered system. Additionally, the invention relates to a computer readable medium in a scalable clustered system that embodies computer program code configured to cause that system to perform steps for configuring and scaling that system. The steps include operatively linking two or more cluster nodes via a global fabric in order to form a larger clustered system. The steps further include routing global packet traffic between the two or more cluster nodes in the larger clustered system via the global fabric; and routing local packet traffic between the one or more end nodes within each of the cluster nodes via the local fabric. The steps additionally include operatively interposing an NNA between the local fabric and the global fabric. As a result, intra-node cluster addressing is transparent to inter-node cluster address changes. As a further result, re-configuration of the scalable clustered system requires no address reassignments yet allowing the end nodes in the cluster nodes to maintain connectivity between themselves.

### REFERENCE TO PRIOR APPLICATION

This application claims the benefit of and incorporates by reference U.S. Provisional Application No. 60/227,899 filed Aug. 25, 2000.

### BACKGROUND OF THE INVENTION

1. Field of the Invention

This application relates generally to scalable computer systems and, specifically, to clustering.

2. Background Art

Scalability is the ability to improve performance by adding resources, such as processors, in a computer system. Scalability allows sizing a system for performance and building a system with redundancy and fault tolerance for greater reliability. As an example, a system with the symmetric multi-processing (SMP) architecture is a scalable system. In a server that embodies the SMP architecture, multiple processors are configured for a shared-memory-I/O parallel processing. However, scalability in the SMP architecture is limited by the shared memory.

Clusters are comparatively more scalable as each server has its own memory and I/O (input-output) channel to peripheral devices. Clustering provides for two or more servers to work cooperatively with each other, sharing processing and I/O resources in a parallel-processing mode. Clustering builds redundancy in a system where multiple servers can be in use simultaneously and, in the event of a server failure, operational servers take over for the failed server. Clusters are further distinguished from SMPs in that clustering allows messages to be sent between systems rather than having communications performed in the shared memory. These messages are sent over an interconnect or a fabric between the resources, and cluster resources are assigned individual addresses that allow messages to be routed to them through this fabric. Each message is broken down into smaller units for transmission. The smaller units, known as packets, can be individually transmitted and routed through the fabric, and each packet contains information about where it needs to be delivered (destination address) and from where it came (source address). The packets are then reassembled by the destination to recreate the original message.

Ideally, clusters should provide continuous service. This means substantially 24 hour a day seven days a week. Therefore additions and deletions of servers should be done without stopping current operation. A ‘good’ cluster allows two or more systems to be joined to the cluster as cluster nodes without suspending the operation of any cluster node. Additionally, clusters should be allowed to join, entirely or partially to form a super cluster, or to separate therefrom, without suspending their respective operations. However, when dealing with an addressable device, it is very difficult to change its address while the device is operation especially when multiple devices are possibly communicating with that device. The most prevalent solutions result in suspended operations while addresses are being modified. Therefore it is desirable to avoid requiring address modification. The present invention deals with this and related issues.

### SUMMARY OF THE INVENTION

In accordance with the purpose of the invention, as embodied and broadly described herein, the invention relates to a scalable clustered system that includes a global fabric, and two or more cluster nodes interconnected via the global fabric. Each cluster node includes a node naming agent (NNA), a local fabric and one or more end nodes interconnected via the local fabric. The NNA is configured as a fully symmetrical translation device interposed between the local fabric and the global fabric.

Each packet includes a source address indicating the originator of the packet, and a destination address indicating the intended recipient of the packet. The NNA provides support for scaled clustering by transforming the source address of each outgoing packet from a fixed (or local) cluster identification number (local cluster ID) to the cluster ID assigned to the cluster node during cluster configuration (global cluster ID). Similarly, the NNA transforms the destination address of each incoming packet from the cluster ID assigned to the node during cluster configuration to the fixed cluster ID. As a result, the intra-node cluster address is transparent to inter-node cluster address changes. As a further result, re-configuration of the scalable clustered system requires no address reassignment yet allowing the end nodes in the cluster nodes to maintain connectivity between themselves.

Further in accordance with the purpose of the invention, as embodied and broadly described herein, the invention relates to a method including steps for scaling the clustered system. Additionally, the invention relates to a computer readable medium in a scalable clustered system that embodies computer program code configured to cause that system to perform steps for configuring and scaling that system. The steps include operatively linking two or more cluster nodes via a global fabric in order to form a larger clustered system. Each of the cluster nodes has end nodes and a local fabric interconnecting the end nodes. The steps further include routing global packet traffic between the two or more cluster nodes in the larger clustered system via the global fabric; and routing local packet traffic between the one or more end nodes in each of the cluster nodes via the local fabric. The steps additionally include operatively interposing an NNA between the local fabric and the global fabric.

In another embodiment, the present invention is implemented as a scalable super-clustered system. This system is a multi-clustered system arranged hierarchically. At a first or primary level of its hierarchy the system is configured with a plurality of global fabrics each of which interconnecting a plurality of cluster nodes to form one or more primary-level clusters. As before, each cluster node includes a node-level node naming agent (NNA), a local fabric and one or more end nodes interconnected via the local fabric. The node-level NNA is configured as a fully symmetrical translation device interposed between its local fabric and one of the global fabrics to which the cluster node is connected.

At an upper level of its hierarchy the system is configured with one or more upper-level global fabrics each of which interconnecting a plurality of the primary-level clusters. This forms one or more upper-level clusters. Each primary-level cluster includes a primary-level NNA that is configured as a fully symmetrical translation device interposed between its global fabric and a particular one of the upper-level global fabrics to which the primary-level cluster is connected.

As a result of the above system configuration, intra-node cluster addressing is transparent to inter-node cluster address changes at any level of the hierarchy. As a further result, re-configuration of the scalable super-clustered system requires no address reassignments yet allowing the end nodes in the cluster nodes to maintain connectivity between themselves.

In the scalable super-clustered system as described above, the node-level NNA is configured to provide support for super-scaled clustering by transforming a local primary-level cluster address into a corresponding upper-level global cluster address for each packet in an outbound path from any of the primary-level clusters. The node-level NNA is configured to provide that support by also transforming an upper-level global cluster address into a corresponding local primary-level cluster address for each packet in an inbound path to any of the primary-level clusters.

Similarly, the primary-level NNA is configured to provide support for super-scaled clustering by transforming a local cluster address into a corresponding global cluster address for each packet in an outbound path from any of the cluster nodes. The primary-level NNA is also configured to transform a global cluster address into a corresponding local cluster address for each packet in an inbound path to any of the cluster nodes.

Advantages of the invention will be understood by those skilled in the art from the description that follows. Advantages of the invention will be further realized and attained from practice of the invention disclosed herein.

### BRIEF DESCRIPTION OF THE DRAWINGS

The accompanying drawings, which are incorporated in and constitute a part of this specification, illustrate several embodiments of the invention and together with the description, serve to explain the principles of the invention. Wherever convenient, the same reference numbers will be used throughout the drawings to refer to the same or like elements.

FIGS. 1a & 1b illustrate examples of clusters.

FIG. 2 illustrates an example of a cluster node.

FIG. 3 illustrates a SAN (system area network) with a scaled cluster arranged in a flat, non-hierarchical manner.

FIG. 4 illustrates the preferred hierarchical approach to building and scaling clustered systems with a plurality of clusters (i.e., global or super clusters).

FIGS. 5 through 17 illustrate the sequence of operations and communications transaction flow.

FIG. 18 illustrates a packet header format.

### DETAILED DESCRIPTION OF THE INVENTION

The present invention operates in the context of scaled computer systems and more specifically in the context of clustering. As a preferred functional and architectural strategy the invention contemplates a hierarchical approach to clustering, particularly in the case of global or super clusters. As will be later explained, global cluster configuration issues are hidden from the local cluster system by inserting between the local fabric of each cluster node and the global cluster fabric a translation device hereafter referred to as the node renaming agent or NNA. Since the hierarchical approach to clustering contemplates a plurality of hierarchy levels, one or more NNAs are introduced as translation devices at each level of the hierarchy.

To enable one of ordinary skill in the art to make and use the invention, the description of the invention is presented herein in the context of a patent application and its requirements. Although the invention will be described in accordance with the shown embodiments, one of ordinary skill in the art will readily recognize that there could be variations to the embodiments and those variations would be within the scope and spirit of the invention.

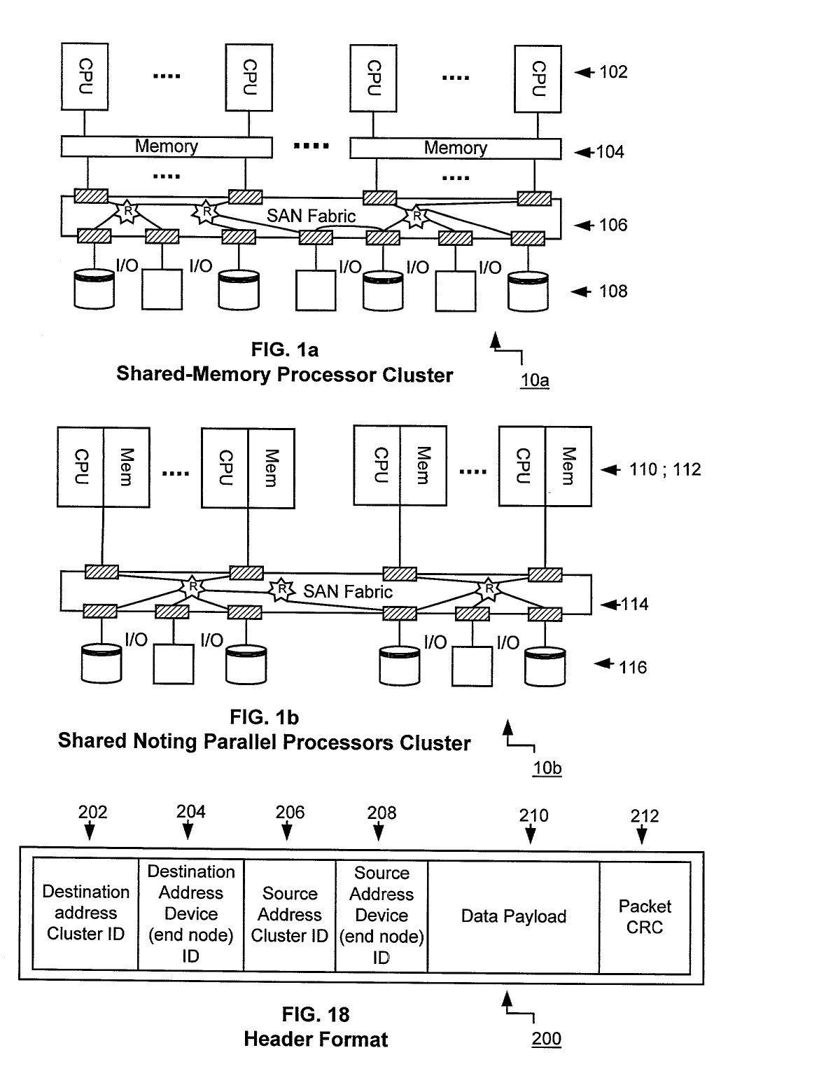

Clustering is used for interconnecting multiple addressable components such as processors (or servers) and their associated I/O controllers. Examples of clusters 10a & 10b are shown in FIGS. 1a-1b. Clusters may be limited in size to a predetermined number of addressable devices, i.e., processors, I/O controllers, and the like; and their size constraints are implementation dependent.

For building a clustered system, a system area network or storage area network (SAN) provides the clustering support infrastructure. This infrastructure is controlled by a software scheme to realize performance and reliability (fault tolerance and high availability). The SAN addresses the need for efficient, reliable communications among the processors 102 & 110 and peripheral devices 108 & 116 in the clusters 10a & 10b. The SAN fabric (hereafter “fabric”) 106 & 114 includes all the switches, routers (shown as R), and cables. The fabric is the network used for routing messages between resources. The fabric constitutes the entire SAN minus the resources; although the fabric includes the management end nodes that may be present in a switch or router. Switches and routers often have a built-in end node for management purposes. The fabric provides the means for directing packets from one end node to another. The resources forming the end nodes 102, 108, 110 & 116, are the addressable devices such as CPUs peripheral device (I/O) controllers, etc. Such addressable devices generate and receive packets and are thus identified by their individual addresses. The interconnections to the SAN can be implemented as back plane buses with fixed connectors normally used for intra-enclosure interconnections or with typical network style cabling, hubs, routers and switches that have very few constraints and allow for typical network style of expansion.

Generally, packet transmission operations on the SAN involve requests followed by corresponding responses. This is true of ServerNet™ and Infiniband™ SANs provided by Compaq Computer corporation of Houston, Texas. Therefore, the packets are sent with both a destination address and a source (response) address. The destination address indicates to where the packet is to be delivered and the source address indicates to where the response is to be returned. When a resource (end node) receives a packet and is generating the response it uses the received source address as the value for the destination address field and its own address as the value for the source address field. Thus, in most SAN implementations both request and response packets contain the source as well as destination addresses. The end nodes may use the source address for validation, but for the purpose of this discussion the function of the source address is to allow determining where to send the response.

In SANs, the routers (R) select proper interfaces (ports) and next hops for packets being forwarded via the fabric. The SAN routers or switches need only the destination addresses to route a packet from the source to the destination. They can ignore the source address field. In many implementations the complete address is not required. Namely, in many implementations the switches or routers require only some of the destination bits to determine where to send a packet. As a result the latency at the switches or routers is reduced. This is a common practice when building wormhole routers. Such routing techniques improve the efficiency of end-to-end communications across multiple links in the fabric. Efficient routing techniques are important in packet transmission operations on the SAN particularly when a scalable system grows larger. Accordingly, the preferred implementation of the present invention uses worm-hole or cut through routing, although the present invention can be implemented with other routing techniques such as store-and-forward routing.

It is noted that a clustered system topology can be designed with router tables and the like which allows the system to be continually expanded without the need to reassign addresses. But this approach requires advance planning. Hence, without the need for such advanced planning, the present invention allows the use of standard building blocks for configuring the system and transparently joining more blocks to it.

It is further noted that a clustered system in accordance with present invention can operate in any network protocol environment. This includes operation in a TCP-IP based network environment (TCP-IP stands for transmission control protocol-Internet protocol).

Scalability allows sizing a system for performance and building the system with redundancy and fault tolerance for greater reliability. A scalable system is capable of providing improved performance by allowing additional resources, e.g., processors to be added thereto. The SAN supports an infrastructure of very large clusters. When resources (end nodes) are added, each resource gets a new and unique address. In addition, routing topologies and their associated routing tables are updated accordingly. The maximum cluster size depends on the size of the packet destination address field because it sets forth the number of end nodes that can be addressed. Thus, a cluster is scalable in that it allows addition of end nodes, but up to a limit. For a scalable system that extends beyond the limits of a single cluster, the SAN can provide multi-clustering support infrastructure. A scalable multi-clustered system is referred to herein as a global cluster or super cluster (these terms can be used interchangeably).

In a global or super cluster, a global fabric interconnects the plurality of clusters. It is noted that a multi-clustered system can be scaled even further. To this end, a ‘higher level’ global fabric can be used to interconnect a plurality of global fabrics. In other words, a larger super cluster can be formed by interconnecting a number of the smaller super or global clusters via a higher-level global fabric.

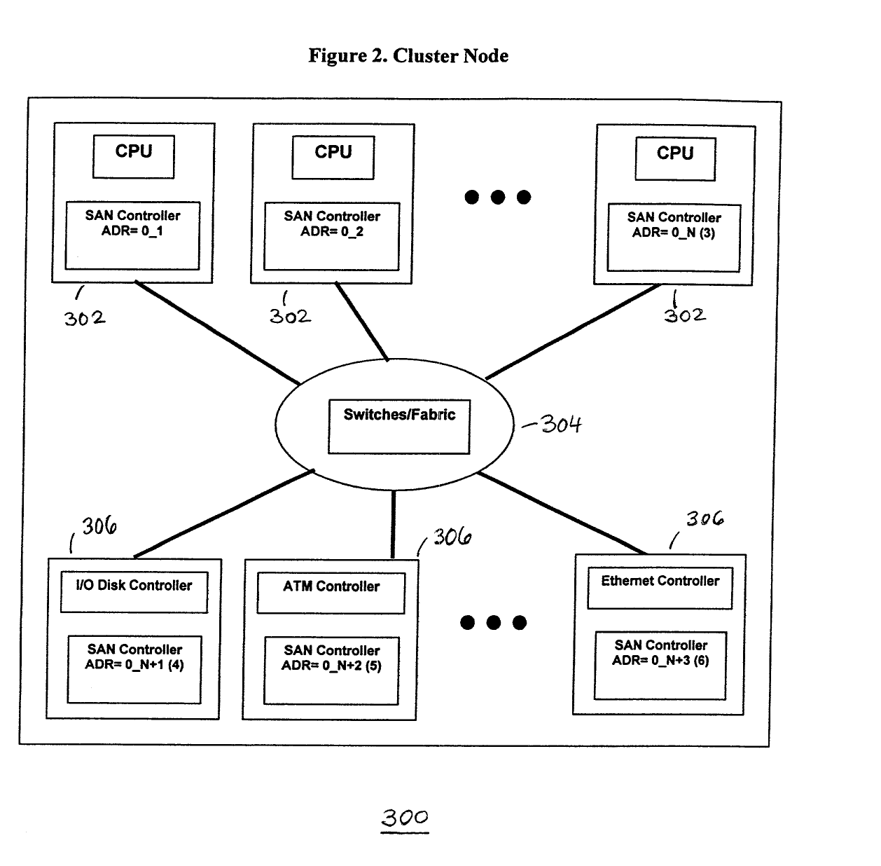

A cluster node in the global or super cluster comprises all of its associated end nodes and its associated local fabric for interconnecting those end nodes. A cluster node is limited in the amount of resources (end nodes) but is large enough to be a viable system. A typical local fabric is associated with 16 CPU's, although it is not limited to this number. An example of a cluster node is provided in FIG. 2. As shown, the cluster node 300 includes its associated local fabric 304 and a plurality of resources 302. In this example, the local fabric is shown interconnecting a plurality of processors, including CPUs and SAN controllers, to peripheral (I/O) device controllers.

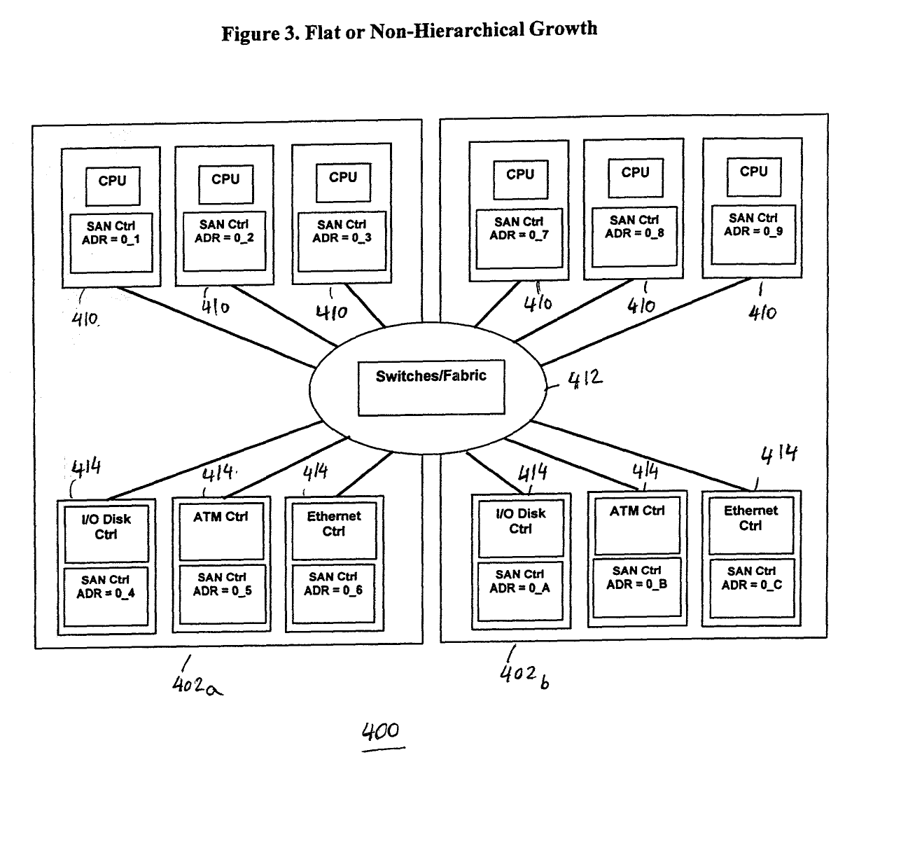

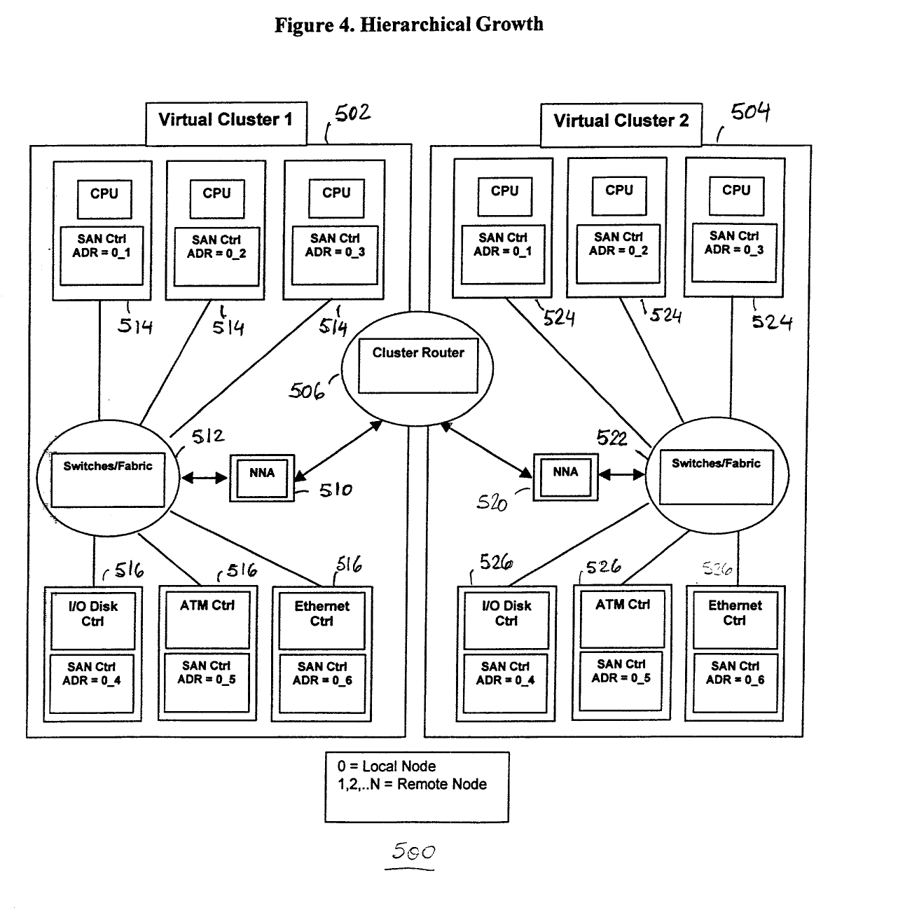

Clusters can be configured in a flat, non-hierarchical manner (as shown in FIGS. 2 and 3), or hierarchical manner (as shown in FIGS. 4-17). Similarly, clustered systems can be scaled in a flat, non-hierarchical or hierarchical manner.

### Non-Hierarchical Scaling

Scaling a clustered system in a flat, non-hierarchical manner involves adding resources in this manner to a cluster. For the purpose of this discussion, FIG. 3 illustrates a SAN with a scaled cluster arranged in a flat, non-hierarchical manner. The scaled cluster joins two sets (402a & 402b) of end nodes that are interconnected via the global fabric 412. Each set includes 3 CPU's 410 and 3 I/O controllers 414. To simplify the description, the SAN is illustrated with a small number of end nodes, although this is not to be construed as a limitation of the SAN. Another simplification is that the address bits to be modified (as will be explained below) can be grouped together. In other words, the present invention can be implemented with the address bits either grouped or not grouped together.

It is noted that while end nodes can join and be part of a cluster, or be removed from the cluster and joined with another cluster, they retain their independent identity and functionality. Namely, regardless of which cluster a particular end node becomes a part of, the particular end node retains its individual identity and functionality in operating and communicating with the other end nodes in such cluster. The same can apply to clusters as will become apparent from the description below.

It is further noted that, when adding an end node to a cluster, or removing the end node therefrom, it is desirable to maintain the end node address unmodified. It is difficult while in operation to change the address of a relocated device especially when multiple devices are communicating with that addressable device. Hence a ‘good’ cluster exhibits the ability to provide substantially continuous service, ideally 24 hour a day seven days a week. Namely, addition of end nodes to a cluster and removal of end nodes therefrom should be done preferably while maintaining current operations. A ‘good’ clustered system exhibits the ability to join two systems that are currently in operation to form the cluster without suspending the operation of any end node in either of the systems.

To that end, a non-hierarchical approach to cluster configuration and scaling provides a less complex addressing scheme. In one implementation of this approach, each and every device ever produced for use in the clustered system is assigned a unique address referred to as cluster ID. Then connecting these devices together never produces duplicate addresses. This approach is simple but it is not the preferred approach as will become apparent. A flat, non-hierarchical cluster configuration or scaling allows a simple extension of the cluster node topology. However, this approach requires careful preplanning of the network topology and limits possibilities for future network re-configuration. In addition, with this approach the address field size makes for a difficult addressing management and requires routers with large routing tables. This also requires different routing tables depending on the chosen end nodes or, alternatively, this requires configuration of a maximum fabric in order to reach these end nodes.

An alternative implementation of the flat, non-hierarchical approach to scaling an existing cluster—i.e., joining one or more end nodes to that cluster—is to reassign all of the addresses used by the added end nodes when they are connected to that cluster. It is possible to build a new cluster using this method by re-assigning addresses to all the end nodes that are joined in the new cluster. This implementation requires simple extension of the cluster node topology. However, the reassignment of cluster IDs impacts traffic in progress because communication links are disabled during reassignment of cluster IDs. Hence, cluster IDs reassignment is intrusive on ongoing communications and causes system down time. Moreover, the cluster ID assigned to newly added end nodes, is largely determined by the cluster IDs already used (i.e., addresses already assigned) and the physical placement of the end nodes. As a result, the flat, non-hierarchical topologies are determined through evolution rather than by design. Hence, accomplishing the assignment of cluster IDs without system interruption imposes many requirements on both the hardware and software, particularly as it relates to fault tolerant systems and testing. This approach creates a very large number of possible combinations and permutations. Therefore, many configurations may not be tested until they are actually used on site.

### Hierarchical Scaling

For reasons as stated above, a hierarchical approach to scaling clusters is preferred over the non-hierarchical approach. FIG. 4 illustrates the preferred hierarchical approach to building and scaling clustered systems with a plurality of clusters (i.e., global or super clusters). As noted before, although the preferred global (super) cluster topology is hierarchical, each cluster node in the super cluster can have a flat, non-hierarchical or hierarchical topology. In this example, each cluster node 502 & 504 includes end nodes, such as one or more CPUs 514 & 524 and I/O controllers (e.g., disk, asynchronous transfer mode (ATM), Ethernet controllers) 516 & 526. Its associated local fabric 512 & 522 that interconnects between the end nodes (514 & 516 and 524 & 526, respectively) of the cluster node. As shown in this example, the super cluster topology is logically divided into two virtual cluster nodes, virtual cluster node 1 (502) and virtual cluster node 2 (504). It is emphasized however that the global or super cluster topology is intended to and indeed supports more than two virtual clusters. For the purpose of the following discussion the virtual cluster nodes are called simply cluster nodes.

Fabric 506 forms the global fabric of the super cluster. The global fabric 506 includes routers for interconnecting between the cluster nodes 502 & 504 of the super cluster 500. Each of the end nodes in a cluster is assigned a local address (i.e., local identification, also known as local ID) that is locally unique to that end node within the cluster. Different end nodes in different clusters may have the same local address. For example, there are two CPUs with local address 1, one in each of the two cluster nodes 502 & 504. Also, for example, there are two I/O controllers with local address 4, but not in the same cluster node. Each cluster node is known locally by the cluster address 0, i.e., the local cluster ID (hence the example addresses above ‘0-1’ and ‘0-4’). This address would prompt the local fabric to route packets locally among the end nodes within their cluster node. However, for global or remote recognition, each virtual cluster (cluster node) is uniquely identified and is known globally by its virtual cluster node ID, or, as it is also known, its global cluster ID, 1, 2, . . . -n. A global address would prompt the local fabric of a cluster node to route packets to the global fabric for further routing to a destination cluster node.

Notably, the global or super cluster topology includes a hardware translation device that functions as a node-naming agent (NNA) 510 & 520. The NNA 510 & 520 is positioned between the respective local fabric 512 & 522 and the global fabric 506 of the super cluster 500. By inserting the NNA into interconnection paths in the hierarchical topology of the super cluster, the present invention essentially hides the aforementioned cluster identification (ID) problem from the local systems (cluster nodes). The NNA translates or maps a specified group of address bits that make up the cluster ID. These bits are not constrained to being contiguous. In the preferred implementation the translation is performed using a value and a mask register where bit substitutions are made as the NNA receives the address bits, without even waiting for the entire address. However, other implementations could use a lookup table to gain greater mapping capability at the expense of latency. In local traffic, a packet will have the local cluster ID. For global traffic, the local cluster ID within the packet is translated by the NNA into global cluster ID, as will be explained in more detail below. With this hierarchical identification scheme, the cluster ID is allowed to remain unchanged for local traffic and be different (translated) for global traffic (between cluster nodes).

It is noted that, as mentioned before, the present invention applies to a TCP-IP based network environment. Previously, TC-IP has evolved from fixed addresses to addresses assigned at connection time from a pool of addresses. By comparison, in accordance with the present invention, the NNA allows addresses, once assigned, to stay constant. This in turn allows a leaf node (end node) to stay connected to a cluster node or a cluster of cluster nodes while the entire cluster node or cluster of cluster nodes is re-assigned. Notably, the NNA can be used to implement an address take-over at the higher level of cluster of cluster nodes rather than only cluster nodes. The NNA produces this result by mapping the address of the cluster node or cluster of cluster nodes rather than mapping the end node address.

Additional advantages of this scheme can be realized. For example, with this hierarchical identification scheme, smaller address fields and routing tables are needed to handle a clustered system. The end node identification process has minimal impact on software latency. Settings of the NNA allow it to communicate safely with another end node to establish cluster membership. A software algorithm in the NNA to implement the foregoing is designed to prevent assignment of same address to two end nodes. The software also includes an algorithm to prevent an end node from being a member of two separate clusters. The hierarchical scheme of the present invention, provides protection against connection failures, detects cables potentially being disconnected and reconnected to different clusters, disables transmits or receives as a result of cable disconnects, detects hardware errors, and handles known damaged packets. The foregoing advantages are realized, however, at the cost of new hardware, particularly the NNA.

Because a hierarchical approach is preferred, the discussion explaining the operations in more detail focuses on a hierarchical approach to scaling clusters. Adding or removing end nodes from any cluster node in modular units and, in turn, adding or removing cluster nodes from the super cluster in modular units scales the clustered system up or down. As mentioned, the cluster nodes may themselves be flat or hierarchical.

### Example of Hierarchical Solutions

As mentioned, the preferred approach is to hide the clustering (identification) issue from the local system (inside a cluster node) by inserting the NNA in the paths between the cluster node and the global fabric as shown in FIG. 4. The NNA provides the hardware support for multi-node clustering. As mentioned, local ID, local cluster ID and global cluster ID are used to distinguish local traffic via the local fabric from global traffic via the global fabric. As compared with the local ID, an end node is identified in packet traffic by its end node ID. An end node ID includes two fields, one being the local ID (e.g., 1) by which the end node is known locally within its cluster node, and one being its associated local cluster ID or, conversely, its virtual cluster node ID (0, 1, 2, . . . etc.). The local cluster ID is for local traffic and the virtual cluster node ID is for global traffic. Hence, the end node source of a packet, i.e., the generator of a request or the responder thereto, are identified locally within their cluster node by, for example, 0-1, and globally within the super cluster by, for example, 1-1. The global identification (e.g., 1-1) is based on the a virtual identification number (e.g., 1) by which the respective cluster node is known globally. The local ID (e.g., 0-1) is the one and only identification that an end node recognizes and responds to. The software supplies the destination address for the packet. The global cluster ID initialization and assignment is discussed latter, for now assume that it is “known”.

Assuming, for the purpose of the following discussion, that in the clustered system of FIG. 4 a packet is sent from an end node in cluster node 1 (502) to an end node in cluster node 2 (504). In particular, it is assumed that a request packet is sent from the generator, CPU1 (CPU with local ID of 1) in cluster node 1 (502; with global cluster ID 1). The request-packet destination is Ethernet controller 6 (with local ID 6) in cluster node 2 (504; with global cluster ID 2). In other words, the request packet is sent from cluster node 1 with a global source address 1_1 to cluster node 2 at global destination address 2_6. It is further assumed that the response packet goes the opposite way from the responder (which is the destination) to the generator.

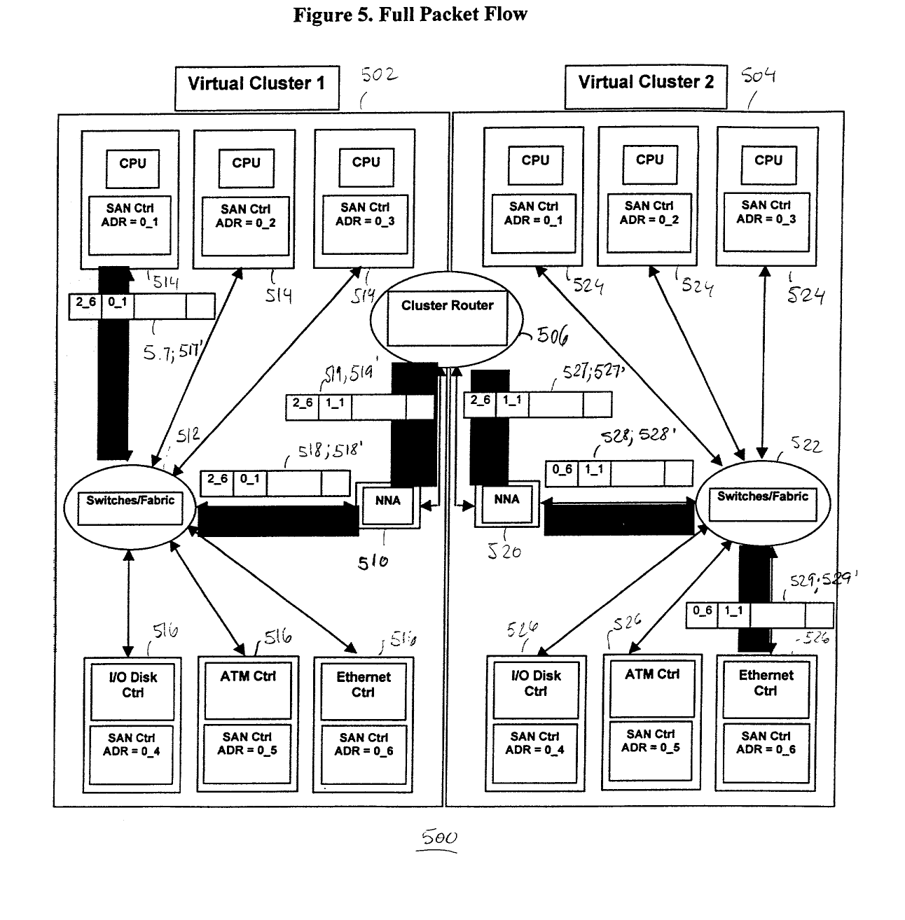

FIGS. 5 through 17 illustrate the sequence of operations (communications transaction flow) as hereafter described.

As shown in FIG. 5, at the point of origination, the packet 517 has a global destination address (2_6) and a local source address (0_1). See: FIG. 18 for packet header format. The packet is routed to the NNA 510 by the local fabric 512. The local source address (0_1) is translated into a global source address on the fly as it passes through the NNA 510. The packet 519 leaves the NNA 510 having global source and global destination addresses. Then the packet 519 is routed by the global fabric (506) to the proper cluster node, in this case cluster node 2 (504). As the packet 527 passes through the NNA 520 of the destination cluster node 504 the global address (2_6) is translated on the fly into a local destination address (0_6). The packet 528 then travels via the local fabric 522. The packet 529 is routed to the destination end node 526 based on the local address (0_6). The response packet 529′ travels in the opposite direction starting from the responder (end node 526), now the source of the response packet. The response packet destination address remains the same as the global source address in the request packet (1_1) while the local source address (0_6) is translated by the respective NNA 520 into a global source address (2_6). The NNA of the (now) destination cluster node (1) translates the global destination address (1_1) in the response packet 519′ into a local destination address (0_1). Then the response packet 518′ is routed to the destination (originator) end node by the local fabric 512 based on the local address (0_1). The response packet 517′ arrives at the proper destination (i.e. the originator of the request packet).

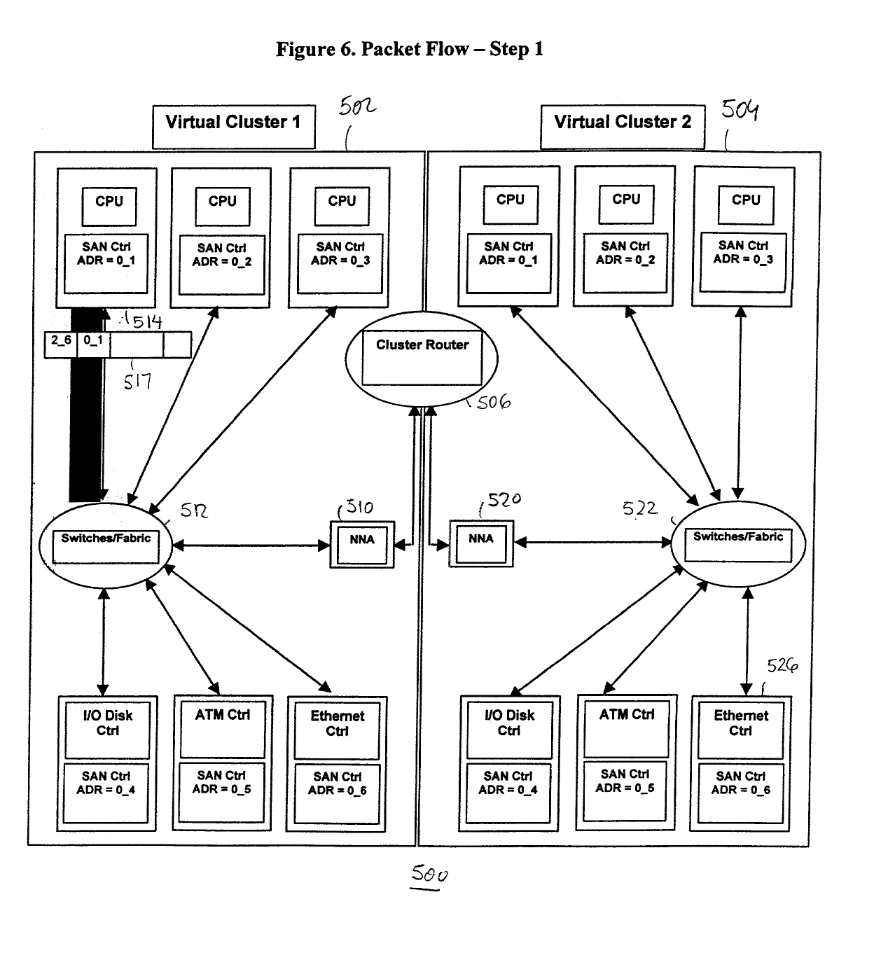

The transaction flow steps just described are shown one step at a time in FIGS. 6-17.

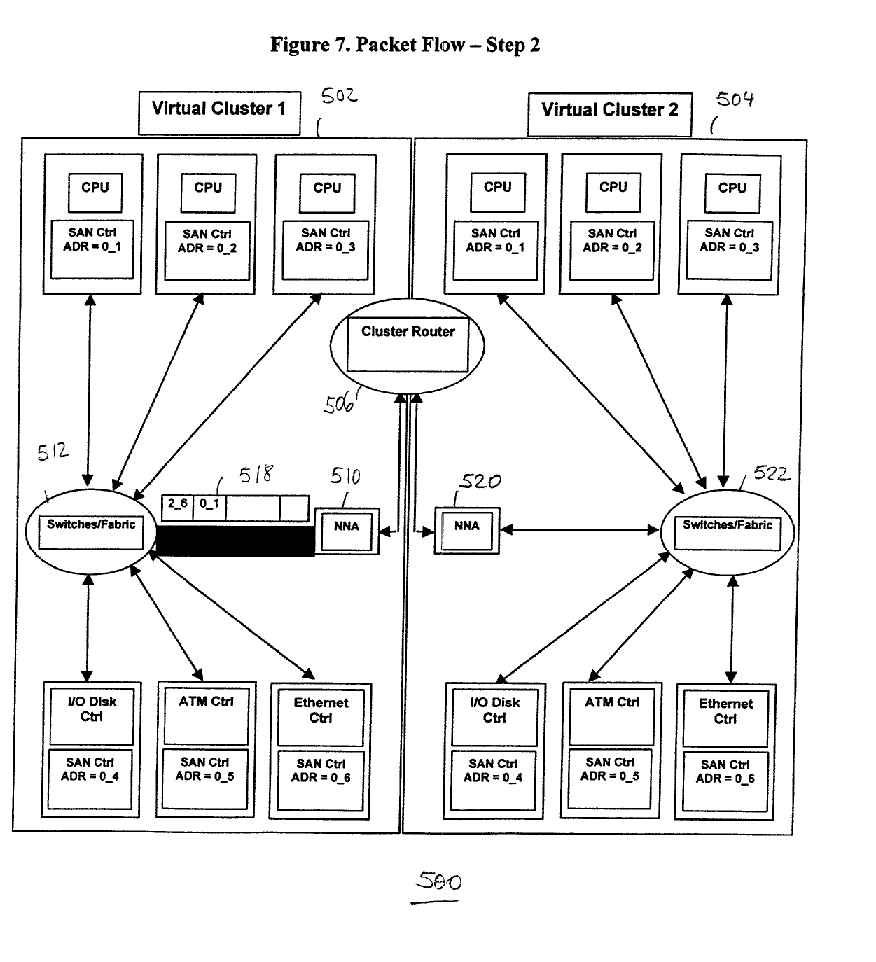

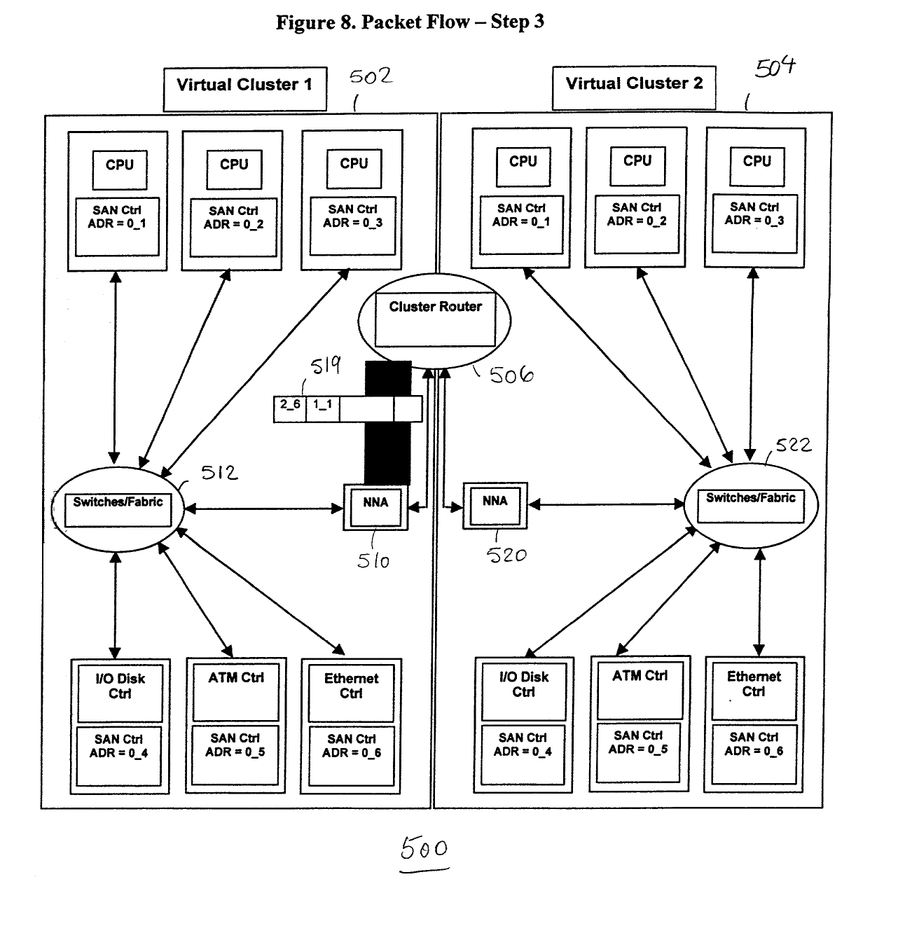

Starting with FIG. 6, a request packet with a global destination address or global destination ID of 2_6 is generated by CPU 1_1 (514) although at the point of origination the source ID in the packet is the local address 0_1. The destination address (2_6) is supplied by the software and is a global address. The source address (0_1) is supplied by the hardware as a local address. The local fabric 520 (inside the cluster node 502) routes the request packet 517 to the local NNA 510, as shown in FIG. 7. As mentioned, at this point the global destination address is 2_6 and the source address is local (0_1). The NNA 510 translates the source address on the fly as the request packet 518 travels through the NNA. As shown in FIG. 8, this produces a packet 519 with a global destination address (2_6) and a global source address (01-01). The request packet 519 is then routed by the global SAN routing fabric 506 and is sent to the correct cluster node 504 (based on the global destination address).

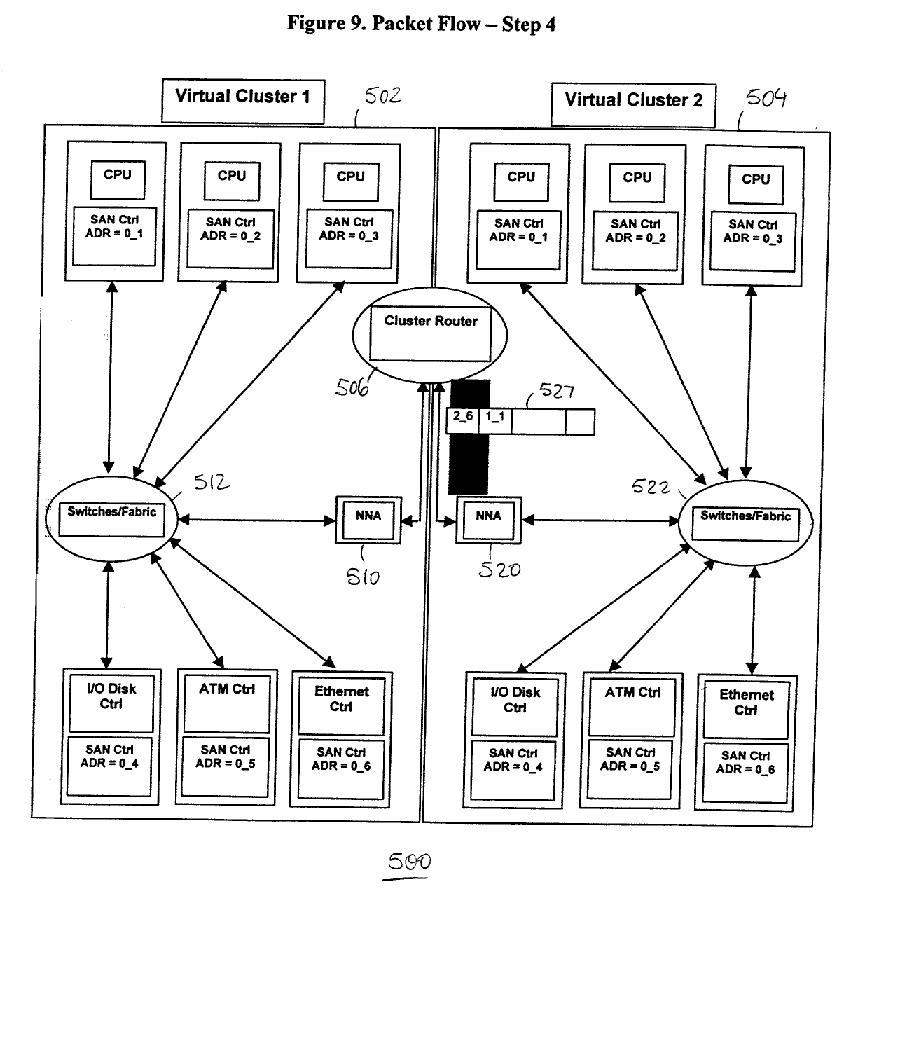

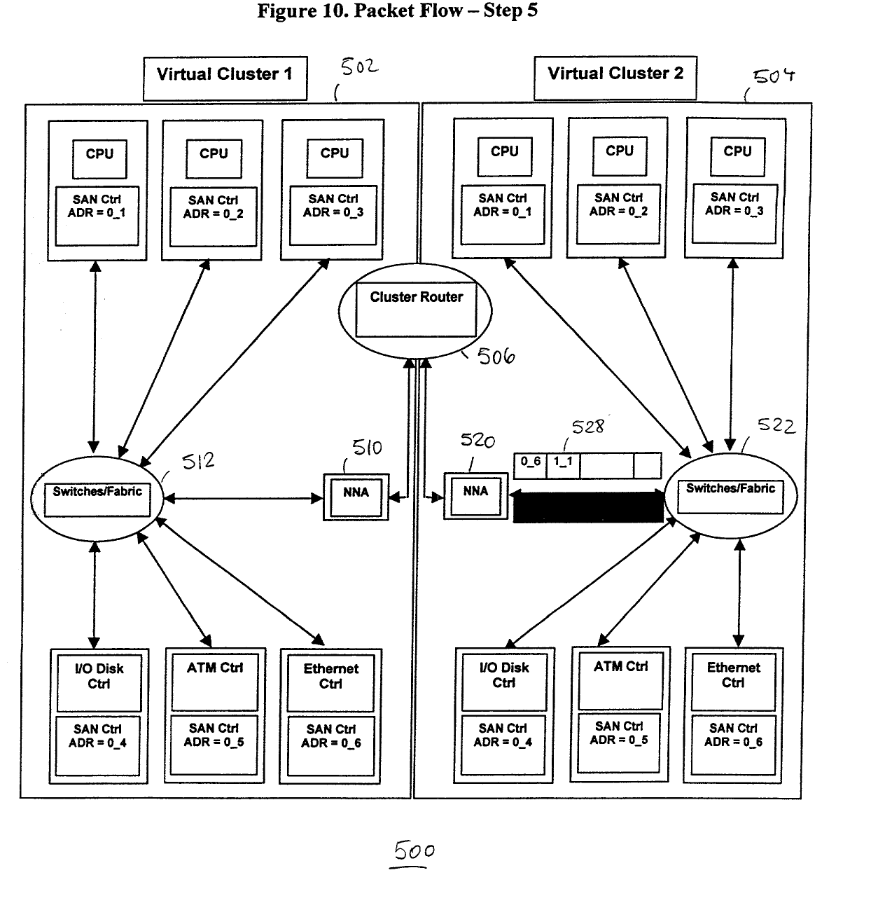

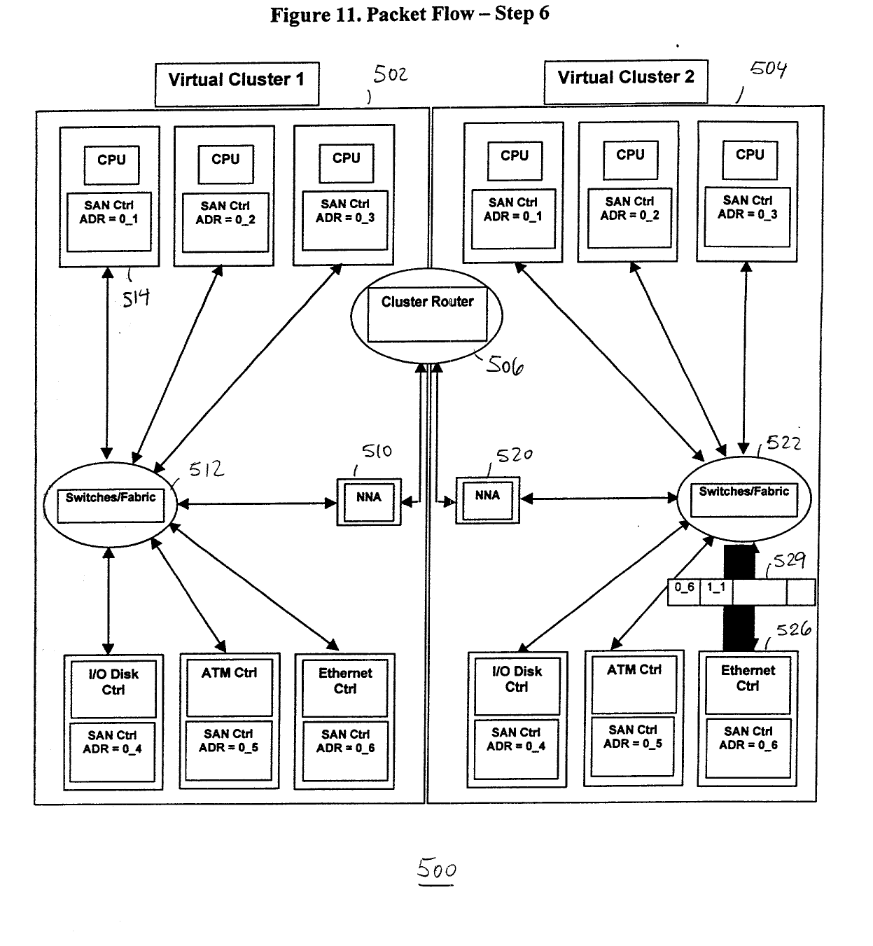

As shown in FIG. 9, the request packet 527 is delivered to the NNA 520 of the targeted cluster node 504. At that instance, the destination address is global (2_6) and the source address is global (1_1). Then the NNA 520 for the targeted cluster node translates the global destination address to a local destination address (within the targeted cluster node 504). Namely, this produces a destination address that is local (0_6) and the source address remains global (1_1). As shown in FIG. 10, from the NNA 520 of the targeted cluster node 504 the request packet 528 is routed through the local fabric 522. As shown in FIG. 11, the local fabric routes the request packet 529 based on the local address (0_6) to the end node 526 (in this case the Ethernet controller 6) for which the request packet was originally intended. Then the destination end node (Ethernet controller 6) 526 performs the requested operation. As can be appreciated from the above, the origin of the request packet (i.e., virtual identification of cluster node 1) is transparent to the end node 526 and the end node performs all requested operations in the same manner regardless of such origin.

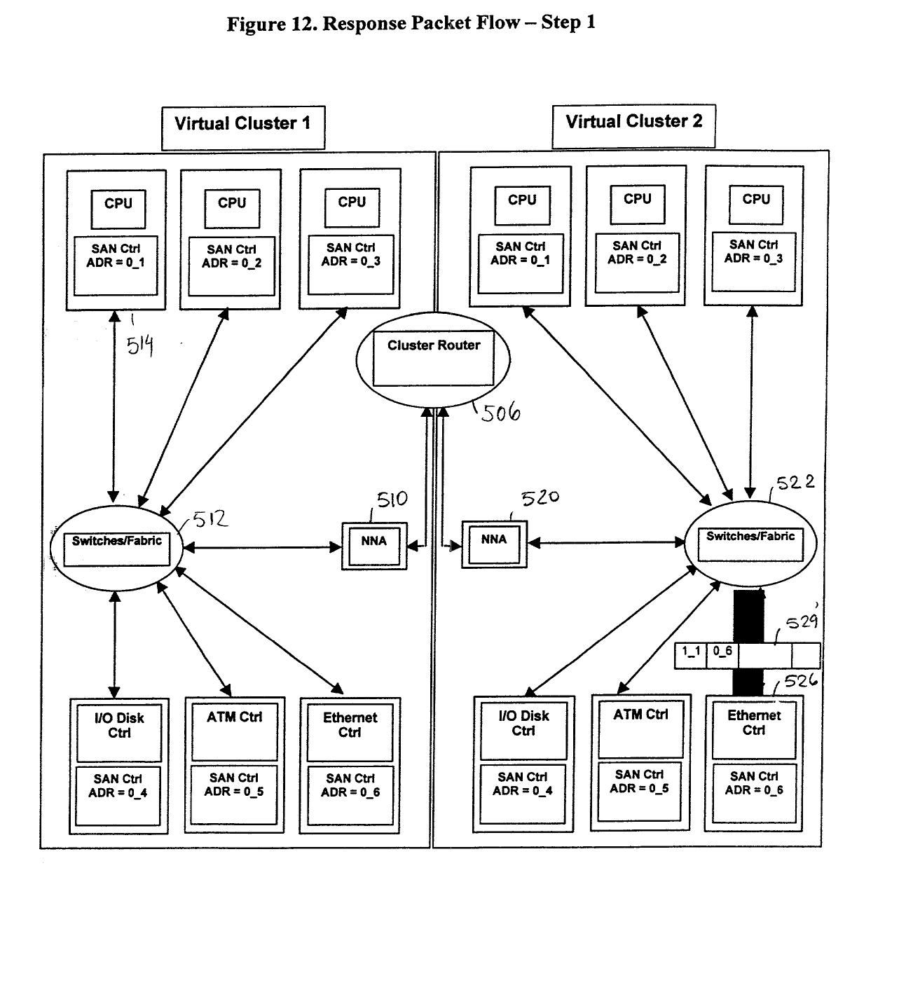

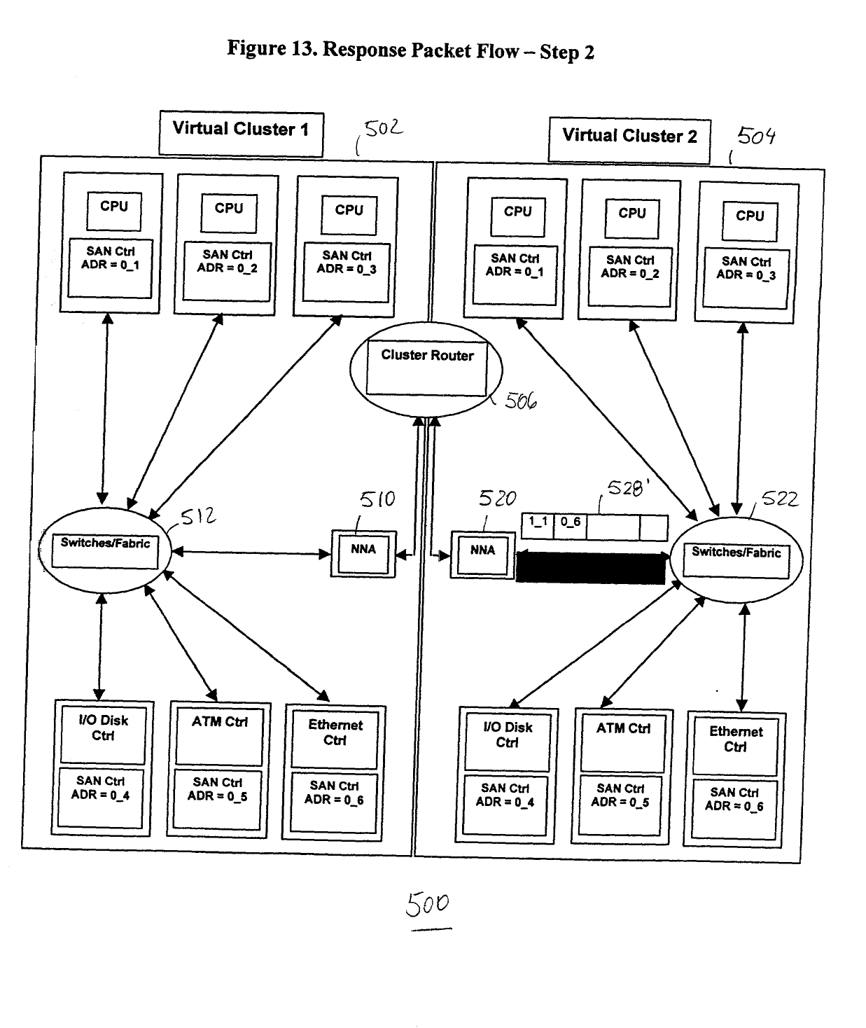

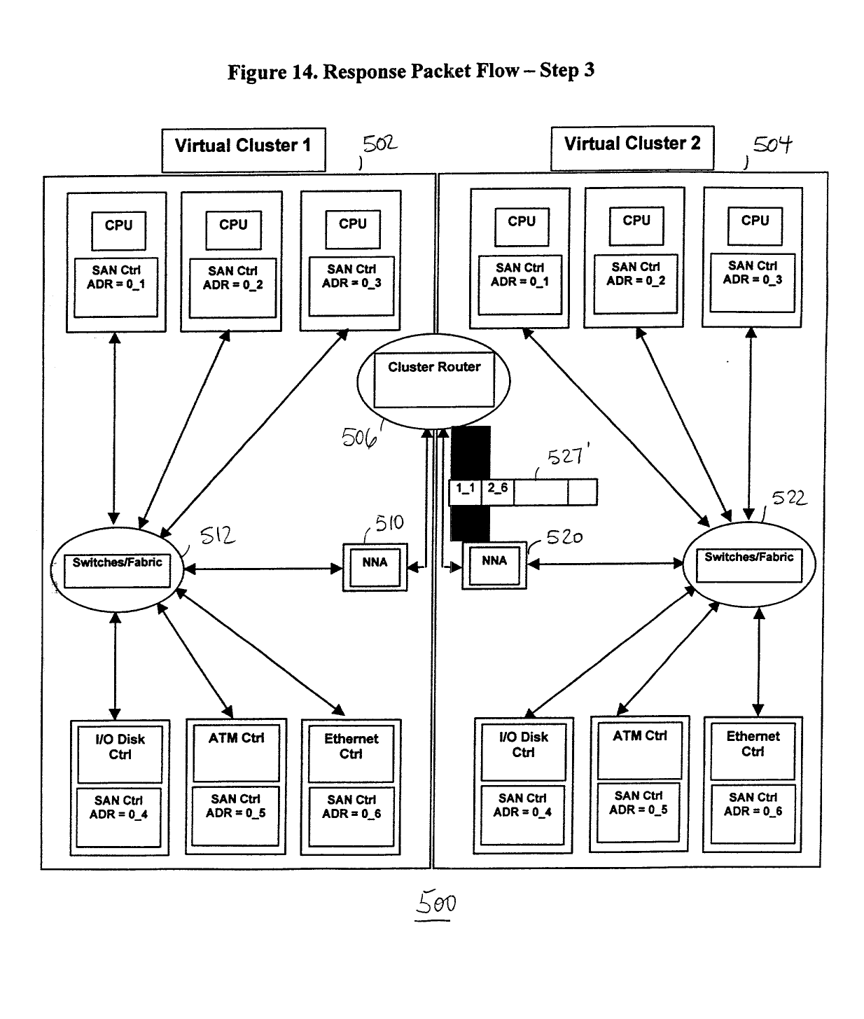

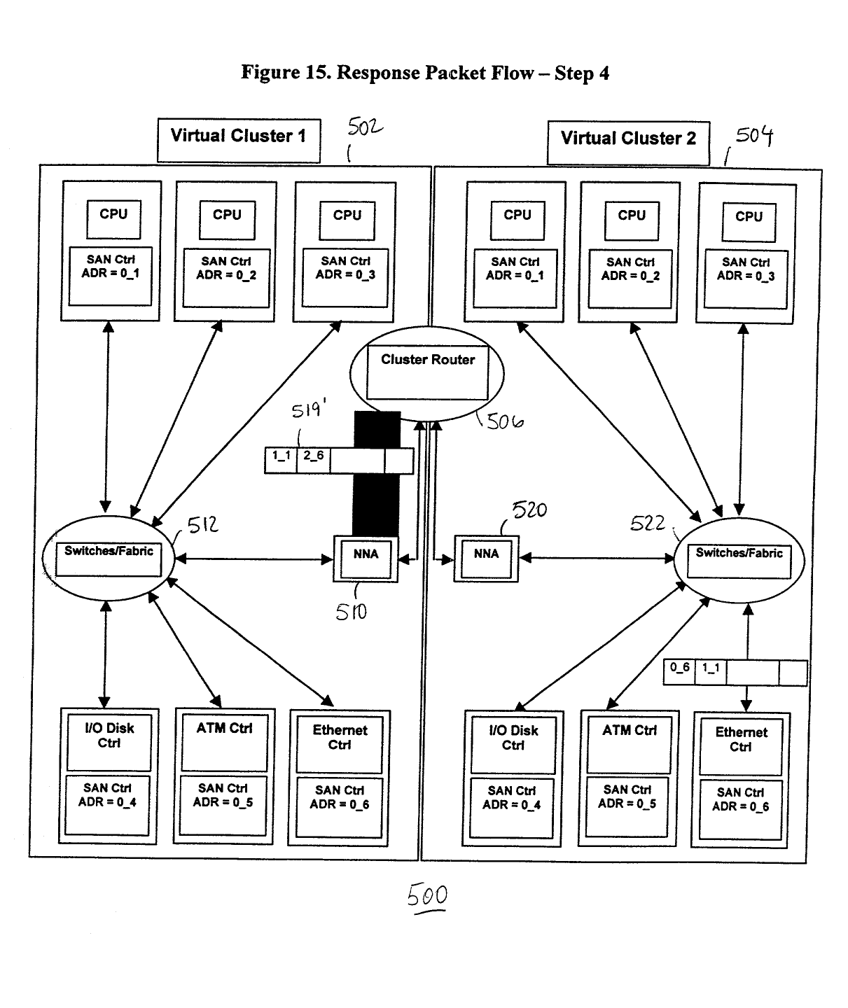

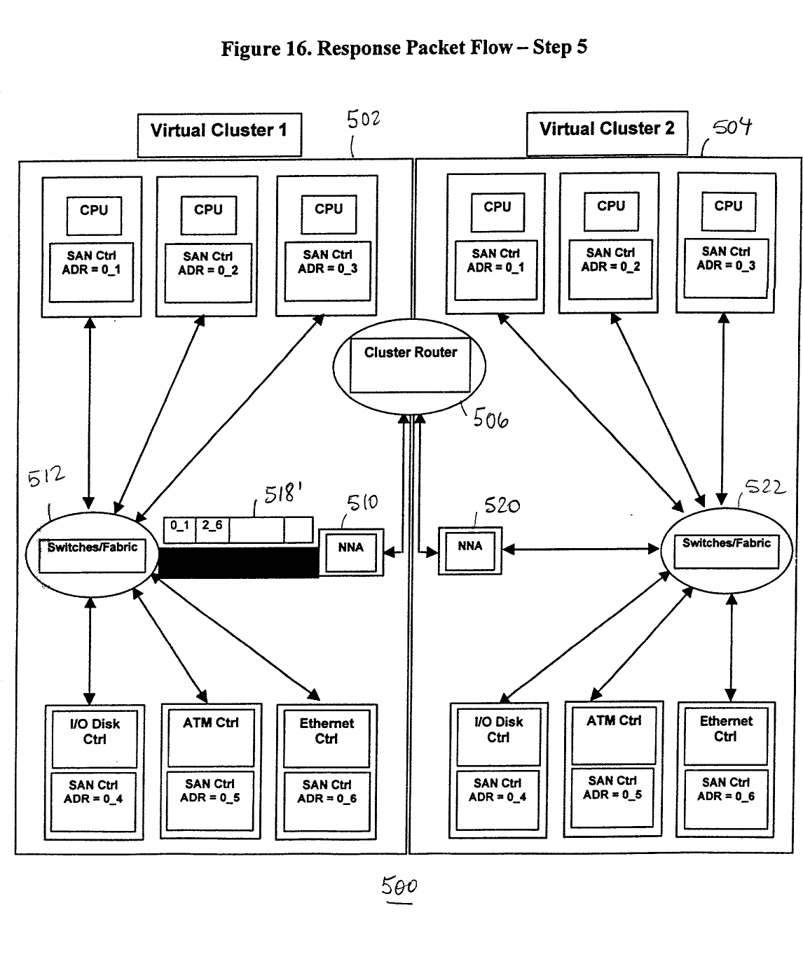

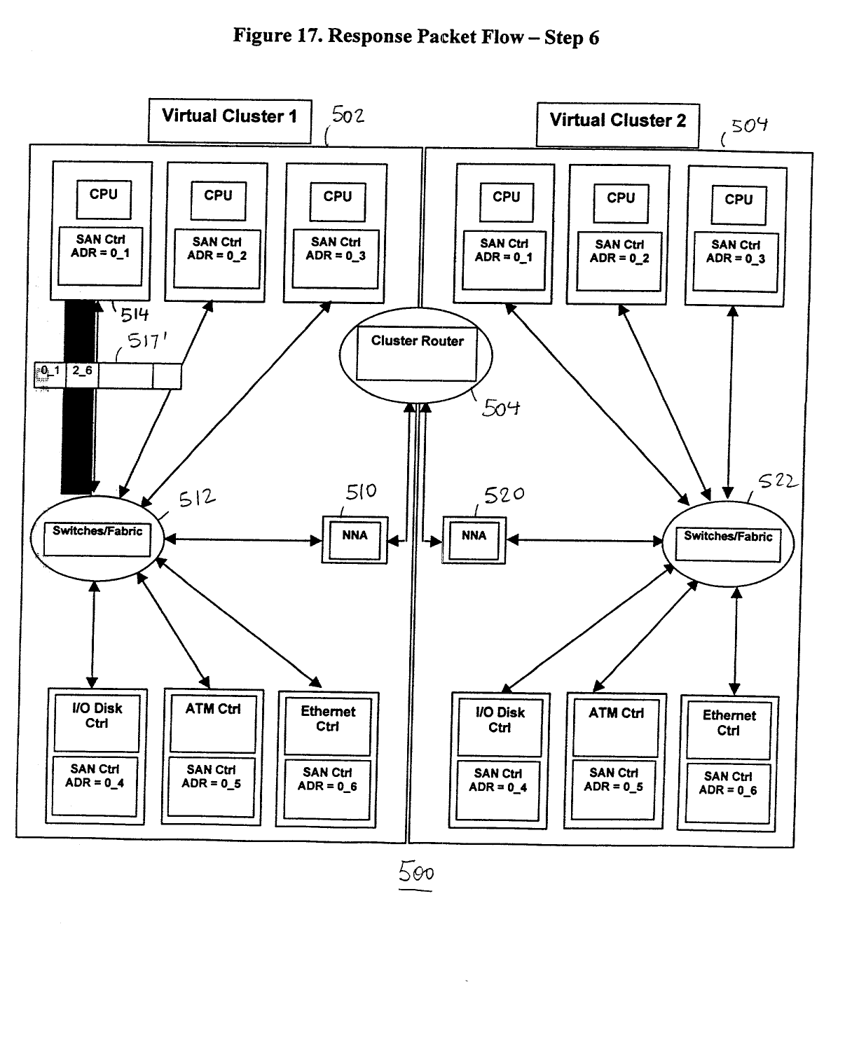

Then, as shown in FIG. 12, the destination end node 526 generates a response packet 529′ and is therefore called the responder. In this example, the responder is the Ethernet controller (6) within the virtual cluster node 2 504 (globally known by 2). The response packet is intended for CPU 514, the originator of the earlier request packet. At the point of it origin (which is end node 526), the response packet 529′ has a global destination address is global (1_1) and a source address that is local (0_6). The response packet 529′ is sent from the responder 526 to the local fabric 522 for routing to its intended destination. As shown in FIG. 13, since the destination address is global (1_1), the local fabric 522 of cluster node 504 routes the response packet 528′ to its associated NNA 522 (rather than an end node in that cluster node). That NNA 522 translates the response packet's source address on the fly as the response packet 528′ passes through the NNA 520. As shown in FIG. 14, that translation produces a response packet 527′ with a global source address (2_6) and a global destination address (1_1). The response packet 527′ is then routed by the global fabric 506 to the intended cluster node 502 based on the global destination address in the response packet 527′. As shown in FIG. 15, the response packet 519′ is delivered by design to the NNA 510 of cluster node of 502. That NNA 510 translates the global destination address (1_1) to a local address (0_1) on the fly as the response packet 519′ passes through that NNA 510. Once translated, the response packet 518′ travels from the NNA 510 to the local fabric 512 of cluster node 502, as shown in FIG. 16. At that point the response packet 518′ has a local destination address (0_1) and a global source address (2_6). Since the response packet 518′ indicates a local destination address (0_1), the local fabric 512 knows to route that packet to a local destination, as is next shown in FIG. 17. Namely, the response packet 517′ is routed from the local fabric 512 to the intended end node, CPU 514 (the originator), based on the local address (0_1). This completes the transaction as intended with the request originator receiving a response packet from the responder.

The description above provides a top-level view of the cluster operations based on the hierarchical solution. It is noted that, although packets (as shown in FIG. 18) contain a source address (206 & 208), a destination address (202 & 204), a data payload (210) and a CRC (cyclic redundancy check; 212), the foregoing description ignores the fact that a CRC is present. Accordingly the description of NNA operation below accounts for the CRC.

### NNA Operations

In an outbound path, NNA operations for an outbound packet passing through the NNA toward the global fabric are outlined below (See: FIGS. 6-11). In an outbound operation, the NNA:

(1) Forwards control and status symbols (non data);

(2) Replaces the local cluster ID value with the global cluster ID value in the packet source address field. That is, the local cluster ID is replaced with its virtual cluster node ID. To that end, two registers are employed, a mask register to indicate which bits are to be replaced and a second register that contains the bits to replace them with;

(3) Performs CRC Recalculation on outbound packet data. In essence, a CRC check is performed on all incoming packets' data. Then, if a bad CRC is detected, a status bit is set for fault isolation purposes and the CRC value in the packet leaving the NNA retains the bad value. This is in order to pass on the failing CRC. If the packet's CRC check is good, then the NNA recomputes the CRC to produce a new CRC (the CRC needs to be recomputed since the source address field was changed). The recomputed CRC replaces the former CRC in that field of the packet. It is noted however, that recalculation is performed if destination ID is enabled (as in ServerNet™ based system) and there is no destination ID mismatch. In addition, when the CRC check is good, the command and link symbols are forwarded unchanged.

In an inbound path, NNA operations for an inbound packet passing through the NNA toward the destination end node from the global fabric are outlined below (The inbound packet flow was described above in FIGS. 12-17). In an inbound operation, the NNA:

(1) Verifies proper routing by checking the destination cluster ID field. If the field is incorrect an incorrect CRC is supplied;

(2) Replaces global destination cluster ID field bits with the local cluster ID field bits, i.e., virtual cluster node ID is replaced with local cluster ID;

(3) Performs CRC checking on all inbound packet data. If a bad CRC is detected then a status bit is set for fault isolation purposes and the CRC value on the packet leaving the NNA for the end node retains the bad value. This is to pass on the failing CRC. If the inbound packets CRC check is good, then the NNA re-computes the CRC to produce a new CRC (the CRC needs to be recomputed since the packet destination ID field was changed and it is included in the CRC). The packet destination address is modified if NNA destination replacement is enabled (i.e., if the NNA operates in a conversion mode).

Thus, for outbound packets the NNA translates local cluster ID values into global cluster ID values that represent the virtual cluster node IDs in the scaled clustered system (i.e. the super or global cluster), and vice versa for inbound packets. Namely, the local cluster ID is used for intra-node packets traffic, and the global (virtual) cluster ID is used for inter-node packet traffic. This way, for each cluster node, the intra-node addressing is transparent to end nodes in other cluster nodes, hence the hierarchy configuration. It is noted that the preferred implementation does not assume the local cluster ID to be only zero (e.g., as in 0_1 and 0_6). Rather, that number is pre-programmed to provide greater flexibility in the choice of numbers.

As an additional detail, a packet header is shown in FIG. 18. Each message 200 contains a source address 206 & 208 and destination address 202 & 204. As mentioned, the destination address 202 & 204 directs where a message packet is to be sent and the source address 206 & 208 indicates to where the response acknowledge packet should be returned. The address field contains a group of address bits that are designated for the cluster ID number. The address used locally within the cluster nodes can be similar for all the cluster nodes. This means that preferably all cluster nodes use the same local cluster number (local cluster ID) for their respective intra-node traffic. The local cluster ID field bits are predefined and cannot be used for generic cluster numbers. If this field is not equal to the “local cluster ID” the packets are sent to a remote cluster. Therefore, all cluster nodes have two different cluster numbers assigned to them. Namely, all cluster nodes have the same local cluster number for local traffic and a unique virtual cluster node number for global traffic.

The discussion has dealt so far with operation of a clustered system using the NNA under steady configuration conditions. However, in the face of configuration changes it is important to make certain that clustered system hardware (including the NNA) does not route messages incorrectly as a result of reconfiguring the cluster, regardless of whether the reconfiguration was intentional or accidental. It is also important that the design provides a controlled method for power up and initialization. Furthermore, the design should provide for controlled fabric topology discovery and enablement for multiple nodes on a dual-fabric, clustered system. Accordingly, the NNA is designed to behave properly even in the presence of operator errors, service errors, hardware failures, power failures and the like. For example, a cluster node can be disconnected from one cluster and connected to another cluster. The NNA allows super-cluster configuration issues to be hidden from local cluster devices.

### NNA Architecture, Initialization and Modes of Operation

### NNA Architecture

As a functional unit, the NNA provides several capabilities that may be individually enabled and disabled. As noted, the NNA is a hardware device, preferably a chip. The NNA is configured as a truly symmetrical translation device interposed between the local fabric and the global fabric. The NNA provides support for scaled clustering by translating local/remote cluster IDs to/from local/remote cluster IDs while maintaining intra-node addressing transparent to external end nodes. The local and remote cluster IDs are used as source or destination addresses in packets.

Stated differently, the packets contain a source address and a destination address, each of which can be either a local or a global address. Thus, there are a number of possible configurations of a request packet: local source local destination (LSLD), local source global destination (LSGD), global source local destination (GSLD), and global source global destination (GSGD). (If it were a response packet heading back to the requesting source it would be LDGS, GDGS, GDLS). Packets with both local source and destination addresses (e.g., LSLD packets) are never seen by the NNA, because the local routing fabric would never route them to the NNA. All packets on the global routing fabric are GSGD packets, because they have both global source and global destination addresses. The NNA modifies packets in one of two ways, depending on whether the packet is heading from the local fabric to the global fabric or from the global fabric to the local fabric. For example, when a (request) packet is heading from the local fabric to the global fabric, it is a LSGD packet. Then the NNA transforms the local source address into a global source address, making the packet a GSGD packet that heads to the global fabric. This GSGD packet is then headed from the global fabric to the local fabric. Then the NNA transforms the global destination address into a local destination address, making the packet a GSLD packet.

Accordingly, the NNA transforms the local source/destination address to a global source/destination address and, symmetrically, the global destination/source address to a local destination/source address (considering that there are request and response packets). This allows graceful scaling and re-configuration of the scalable clustered system without address reassignments so that the scaled clustered system can maintain uninterrupted operations.

As implemented, the NNA chip is connected on both ends to a fabric and its functionality is built symmetrically (for equal features at each end). Included in the NNA chip implementation is a control register with bits that enable or disable various aspects of the NNA functionality. Thus, because of its symmetrical configuration, the bits in the control register of the NNA chip are replicated, one for each end of the NNA chip. The bit-function correlation is outlined as follows:

1) Shutdown on missing clock enable—if this circuitry detects loss of clock or a loss of optical signal (LOS) the chip is prohibited from transmitting or receiving data or symbols;

2) Replace destination address enable—enables the replacement of the destination field;

3) Replace source address enable—enables the replacement of the source field;

4) Destination address checking enable—this function enables checking of the destination address of the received packet.

5) Enable pass through—enables the chip to pass received symbols and data to the output port unchanged.

In this embodiment, additional NNA architectural details include:

1) Each end of the NNA chip has a separate mode control register. If all mode bits in the mode control register are cleared, that end will be put into shutdown mode. In shutdown mode, if receive clocks are present, then transmit clocks will be present and the idle symbols (no data) will be transmitted. If receive clocks are not present, then transmit clocks will not be present. This behavior is mimicking the effect a simple cable would have.

2) Upon power-up, the mode bits for both ends will be cleared, thus putting both ends in shutdown mode.

3) The reset to the NNA clears all the mode bits for both ends, thus putting both ends in shutdown mode.

4) Software can programmatically enter shutdown mode at any time by clearing the mode register(s) with a write operation of all zeroes.

5) Whenever LOS (or loss of clock on either end) is detected, the NNA will clear the mode bits on both ends, thus forcing both ends into shutdown mode. The other control and status bits are not modified by the NNA.

### NNA Initialization

On a soft reset, the NNA is initialized to the default mode—pass-through—that does not provide for the local/global address conversion or clock checking. Upon initialization, the NNA is set for communicating safely with another end node in order to establish its cluster membership. It is noted that no two nodes have the same end node ID within the cluster node. In addition, the NNA is set for communicating safely with another global fabric in order to join a global cluster membership.

On a hard reset, the NNA goes through an initialization process whereby its registers are set to their default values. On a hard reset, NNA initialization includes:

1) sets the mode control registers to clock check or pass through mode. The mode control registers are used to select the NNA mode of operation;

2) loads the needed values into the data replacement registers. The data replacement registers are programmable with the identification information necessary to convert a local cluster ID into a global cluster ID (or a virtual cluster node ID) and, conversely, a global cluster ID into a local cluster ID.

3) loads multiplexer (mux) information into the mux control registers; and

4) enables data replacement—mode control register. In a ServerNet™ based system, this initialization step involves enabling data replacement of source ServerNet™ ID (SID), destination ServerNet™ ID or CRC.

It is noted that, although not a necessary initialization step, a possible default value may include disabled data replacement in the mode control register. In a ServeNet™ based system, this involves disabling data replacement of source ServerNet™ ID (SID), destination ServerNet™ ID or CRC;

### Modes of Operation

Once NNA initialization is complete, the NNA proceeds in one of a number of operating modes. The NNA mode of operation depends on the settings of the mode bits and the state of certain status bits. The status registers reflect the state of inbound and outbound CRC and clock.

The following NNA operating modes are possible:

1) pass-through mode—is a mode in which the NNA performs no translation or checking. This is the default mode upon initialization. In a ServeNet™ based system this is a mode in which the NNA fowards ServeNet™ packets without changing any of the packet fields. If clock checking was previously enabled, the clock lost sticky bit must be cleared before resuming operation in pass through mode;

2) conversion mode (normal operation mode)—is a mode in which the NNA performs translation, clock checking, and destination address checking (in a ServeNet™ bases system, DID checking). In the conversion mode, the NNA converts one of the ID fields in the packet header (source or destination ID) to reflect the configurable cluster number, and recalculates the packet CRC. In this mode, the NNA forwards command without any translation. Loss of clock in this mode forces the NNA into the shutdown mode;

3) clock check mode—is clock monitoring mode in which translation is not performed. It is similar to pass through mode in the sense that it allows the NNA to forward all packets and command symbols without translating any fields in the servernet packets. Loss of clock forces the NNA into the shutdown mode;

4) error check mode—is a monitoring/error-detection mode where the possible errors are loss of clock, bad CRC, or bad DID. Errors can be detected either before or after ID or CRC fields of the packets are changed. Preferably, when the NNA detects a CRC error, it sets the status bit that notes the bad CRC, but the NNA does not modify the CRC. This leaves the error intact to be later treated by a router (switch) that will append. Preferably also, the status bit is later cleared by the software;

5) error recovery mode—is a mode entered to on the discovery of any of the forgoing errors. An error indicating loss of clock, may cause shutdown;

6) shutdown mode is a mode to which the NNA enters if the clock is lost on the link and the NNA was in either the normal operation (conversion) mode or the error check mode. In the shutdown mode the NNA records the loss of clock in the clock_lost status bit. The NNA remains in shutdown mode until it is re-enabled (re-programmed) via the data replacement registers and the clock on the link is again present (by clearing the NNA clock_lost status bits). In the shutdown mode, the NNA is in non-programmatic state and needs to be re-programmed to return to the previous modes of operation (conversion or monitor) after the clock is present on the link. In the shut down mode the NNA also drives the lines to a constant level.

### Configuration Solutions Provided with the NNA

A connection between nodes in a clustered system (super or global cluster) can fail by reasons such as service operator or hardware errors. It is important that the failure of a connection does not affect the cluster system. As an example, some problems (faults) and the relevant solutions provided thereto by the NNA are described below.

1) Fault: A cable connecting the end node to the local fabric is pulled and placed into another local fabric belonging to a different cluster node. The time to swap the cable could be very fast (1 sec). Without hardware assistance, the software would be required to notice that the cable has been disconnected and terminate all transfers from any CPU through this link to ensure packets are not transmitted onto the new fabric that were intended for the previous fabric. In a similar fashion, incoming packets could also be erroneously delivered.

Solution: When the NNA detects the loss of clocks, the hardware disables NNA transmit and receive functions. The software is required to re-enable transmission and reception of packets. The software is required to shut down all existing communication with this link before enabling it again. This guarantees synchronization between hardware and software.

2) Fault: The NNA component fails and bad packets are generated. If the NNA fails the packets may be damaged in a detectable fashion such as bad CRC. These types of faults are minor, since the local and global fabrics must already deal with packet errors. The critical issue is that this logic is modifying the packet and its associated CRC. Thus the logic has the potential for generating undetectable packet errors. A simple example is dropping a bit on the cluster node ID number.

Solution: The NNA component is built using self-checking logic (duplication and other checking techniques can be employed.). If the self-checking logic detects incorrect operation, packet transmission and reception are terminated.

3) Fault: The incoming packet has a CRC error.

Solution: The packet is transmitted with a CRC error.

4) Fault: Global fabric routers fail and incorrectly send a packet to the wrong NNA. The packet has the wrong destination address, which will be replaced by the NNA. This packet is a good local packet that has been delivered to the wrong end node.

Solution: The NNA checks the incoming packet for the correct destination address. If it does not match this port the packet is nullified by not appending the correct CRC.

Among the attributes of the cluster hardware and software it is important to note the ability to configure all cluster nodes identically, except for their NNA. It is further noted that although the discussion so far has centered on a single fabric, there are additional configuration variations. For example, when high availability for fault tolerance is desired, some replication of key elements such as the NNA or the fabric (including routers and switches) is required. For example, the entire fabric may be duplicated. It is also noted that the end node IDs on one local fabric do not need to be the same as on the other fabric.

In summary, the present invention provides a method and system for configuring and scaling clustered systems without causing detriment to their ongoing operations. The preferred functional and architectural strategy includes a hierarchical approach to clustered system configuration and scaling. In addition, global or super cluster configuration and scaling issues are hidden from end nodes by inserting the NNA between local and global fabrics of the clustered system. Notably, the NNA can be inserted between any two fabrics in order to allow (global) transactions that are transparent (on the local level) to end nodes within the clusters. By providing the NNA and the hierarchical topology in a system, advantages realized by the present invention include but are not limited to:

1) allowing two or more cluster nodes to be connected together to form a larger, super clustered computer system without advance planning or knowledge of the target super cluster configuration;

2) allowing addition, removal, or configuration of any cluster node without reconfiguring the preexisting cluster nodes or the cluster node being moved (added or removed);

3) allowing the super cluster routing and the global fabric topology to be transparent to the cluster node in operation (i.e., transparent to the software running in the cluster node);

4) allowing the clustered system to scale gracefully and operate more efficiently as a whole even if local software latencies grow and the software response is slow or non-existent;

5) allowing connection(s) to be moved from one router (or switch) port to another port on the same super cluster or even another super cluster without causing any incorrect behavior;

6) allowing addresses identifying the cluster nodes (cluster node ID) to remain unchanged and yet allowing the end nodes in the cluster nodes to maintain connectivity therebetween when the cluster nodes are joined in a super cluster, added (connected) to a pre-existing super cluster, removed from the super cluster, or moved (re-connected) to another super cluster; and

7) allowing a cluster node to be disconnected from one super cluster and, without regard to its past relationship with any super cluster, be connected or re-connected to a separate super cluster without impacting that cluster node's internal traffic behavior.

Although the present invention has been described in accordance with the embodiments shown, variations to the embodiments would be apparent to those skilled in the art and those variations would be within the scope and spirit of the present invention. Accordingly, it is intended that the specification and embodiments shown be considered as exemplary only, with a true scope of the invention being indicated by the following claims and equivalents.

What is claimed is:

1. A scalable clustered system, comprising:
a global fabric; and
two or more cluster nodes interconnected via the global fabric, each cluster node including a node naming agent (NNA), a local fabric and one or more end nodes interconnected via the local fabric, the NNA being configured as a fully symmetrical translation device interposed between the local fabric and the global fabric, the NNA providing support for scaled clustering by transforming a local cluster address into a corresponding global cluster address for each packet in an outbound path from any of the cluster nodes and by transforming a global cluster address into a corresponding local cluster address for each packet in an inbound path to any of the cluster nodes, wherein intra-node cluster addressing is transparent to inter-node cluster address changes, and wherein re-configuration of the scalable clustered system requires no address re-assignments yet allowing the end nodes in the cluster nodes to maintain connectivity therebetween.

2. A scalable clustered system as in claim 1 wherein the local fabric and global fabric provide local and global clustering support infrastructures, respectively, and wherein global routing and global fabric topology are transparent to end nodes in operation.

3. A scalable clustered system as in claim 1 wherein the local and global fabric are each configured with one or more routers and/or switches.

4. A scalable clustered system as in claim 1 wherein each of the end nodes is an addressable device representing a resource such as a microprocessor, a central processing unit (CPU), a memory, an input/output (I/O) device controller or a server.

5. A scalable clustered system as in claim 1, the re-configuration of which, by addition thereto or removal therefrom of any cluster node, is possible while maintaining the configuration of any of the other cluster nodes, and wherein configuration of any of the cluster nodes is possible without reconfiguration of any of the other cluster nodes.

6. A scalable clustered system as in claim 1 wherein connections in the local and global fabric can be modified while maintaining correct packet transmission behavior.

7. A scalable clustered system as in claim 1 wherein the number of end nodes in each cluster node corresponds to an attribute of address fields in packets.

8. A scalable clustered system as in claim 1 wherein the NNA is configured to prevent a duplicated assignment of any end node address in establishing end node membership in a cluster node.

9. A scalable clustered system as in claim 1 wherein the scalable clustered system has a hierarchical topology and wherein each of the cluster nodes has either a flat or a hierarchical topology.

10. A scalable clustered system as in claim 1 wherein local traffic of packets within any of the cluster nodes is not routed to its respective NNA.

11. A scalable clustered system as in claim 1 wherein global traffic of packets to and from each of the cluster nodes is routed via its respective NNA.

12. A scalable clustered system as in claim 1 wherein the NNA includes a mask register for transforming the global/local cluster addresses in which bit substitutions can be made before an entire address has arrived at the NNA.

13. A scalable clustered system as in claim 1 having hierarchical topology and address-identification scheme that relative to flat non-hierarchical topology require smaller address fields and routing tables.

14. A scalable clustered system as in claim 1 wherein the NNA is a semiconductor chip.

15. A scalable clustered system as in claim 1 wherein the NNA has symmetrically built ends with one end being connected to the local fabric and the other end being connected to the global fabric and wherein a capability replicated at each end includes status indications and control enable bits.

16. A scalable clustered system as in claim 15 wherein the control enable bits include a shutdown on missing clock enable, a replace source address enable, a replace destination address enable, a destination address checking enable and a pass-through enable.

17. A scalable clustered system as in claim 1 wherein the NNA has a mode control register the contents of which determines which mode of operation the NNA assumes.

18. A scalable clustered system as in claim 17 wherein the NNA modes of operation include a pass-through mode, a conversion mode, a clock-check mode, an error check mode an error recovery mode and a shutdown mode.

19. A scalable clustered system as in claim 1 wherein, while in the conversion mode, the NNA is configured to perform source or destination cluster identification (ID) translation, clock checking and destination address checking.

20. A scalable clustered system as in claim 18 wherein the pass-through mode is a default mode of the NNA upon initialization.

21. A scalable clustered system as in claim 1 wherein NNA includes data replacement registers programmable with information for converting local cluster address to global cluster address and global cluster address to local cluster address.

22. A method for scaling a clustered system, comprising:
operatively linking two or more cluster nodes via a global fabric in order to form a larger clustered system, each of the cluster nodes having end nodes and a local fabric interconnecting the end nodes;
routing global packet traffic between the two or more cluster nodes in the larger clustered system via the global fabric;
routing local packet traffic between the one or more end nodes within each of the cluster nodes via the local fabric; and
operatively interposing an NNA between the local fabric and the global fabric, the NNA being configured as a fully symmetrical translation device, the NNA providing support for scaled clustering by transforming a local cluster identification (ID) into a corresponding global cluster ID for each packet in an outbound path from any of the cluster nodes and by transforming a global cluster ID into a corresponding local cluster ID for each packet in an inbound path to any of the cluster nodes, wherein intra-node cluster addressing is transparent to inter-node cluster address changes, and wherein re-configuration of the scalable clustered system requires no ID re-assignments yet allowing the end nodes in the cluster nodes to maintain connectivity therebetween.

23. A method as in claim 22 wherein in the outbound path the NNA performs steps including
forwarding control and status symbols,
replacing a local cluster ID value with a global cluster ID value in a packet source address field if the NNA operates in a conversion mode, and
establishing a cyclic redundancy check (CRC) value in an outbound packet CRC field based on whether a correct or incorrect CRC value is detected.

24. A method as in claim 23 wherein the CRC value is re-computed if a correct CRC value is detected, a destination cluster ID is enabled and there is no destination cluster ID mismatch.

25. A method as in claim 24 wherein in the inbound path, the NNA performs steps including
forwarding control and status symbols,
verifying proper routing by checking a destination cluster ID field in an inbound packet,
detecting a correct or incorrect CRC value in the inbound packet,
setting a status bit if the incorrect CRC value is detected, and
replacing a global cluster ID value with a local cluster ID value in a packet destination address field if the NNA operates in a conversion mode.

26. In a scalable clustered system, a computer readable medium embodying computer program code configured to cause that system to perform steps for configuring and scaling that system, comprising:
operatively linking two or more cluster nodes via a global fabric in order to form a larger clustered system, each of the cluster nodes having end nodes and a local fabric interconnecting the end nodes;
routing global packet traffic between the two or more cluster nodes in the larger clustered system via the global fabric;
routing local packet traffic between the one or more end nodes within each of the cluster nodes via the local fabric; and
operatively interposing an NNA between the local fabric and the global fabric, the NNA being configured as a fully symmetrical translation device, the NNA providing support for scaled clustering by transforming a local cluster address into a corresponding global cluster address for each packet in an outbound path from any of the cluster nodes and by transforming a global cluster address into a corresponding local cluster address for each packet in an inbound path to any of the cluster nodes, wherein intra-node cluster addressing is transparent to inter-node cluster address changes, and wherein re-configuration of the scalable clustered system requires no address reassignments yet allowing the end nodes in the cluster nodes to maintain connectivity therebetween.

27. A computer readable medium as in claim 26 wherein the computer program code is further configured to cause the NNA to prevent
assignment of a same local address to two end nodes in the same cluster node, and
associating an end node with more than one cluster node.

28. A scalable clustered system, comprising:
global interconnection means for operatively linking two or more cluster nodes in order to form a larger clustered system, each of the cluster nodes having end nodes;
local interconnection means for operatively linking the end nodes within each of the cluster nodes;
global routing means for routing global packet traffic between the two or more cluster nodes in the larger clustered system via the global interconnection means;
local routing means for routing local packet traffic between the one or more end nodes within each of the cluster nodes via the local fabric means; and
translation means operatively interposed between the local interconnection means and the global interconnection means, the translation means being configured as a fully symmetrical translation device, the translation means providing support for scaled clustering by transforming a local cluster address into a corresponding global cluster address for each packet in an outbound path from any of the cluster nodes and by transforming a global cluster address into a corresponding local cluster address for each packet in an inbound path to any of the cluster nodes, wherein intra-node cluster addressing is transparent to inter-node cluster address changes, and wherein re-configuration of the scalable clustered system requires no address re-assignments yet allowing the end nodes in the cluster nodes to maintain connectivity therebetween.

29. A scalable super-clustered system, comprising:
a primary level of hierarchy configured with a plurality of global fabrics each of which interconnecting a plurality of cluster nodes to form one or more primary-level clusters, each cluster node including a node-level node naming agent (NNA), a local fabric and one or more end nodes interconnected via the local fabric, the node-level NNA being configured as a fully symmetrical translation device interposed between its local fabric and one of the global fabrics to which the cluster node is connected; and
an upper level of the hierarchy configured with one or more upper-level global fabrics each of which interconnecting a plurality of the primary-level clusters to form one or more upper-level clusters, each primary-level cluster including a primary-level NNA that is configured as a fully symmetrical translation device interposed between its global fabric and a particular one of the upper-level global fabrics to which the primary-level cluster is connected,
wherein intra-node cluster addressing is transparent to inter-node cluster address changes at any level of the hierarchy, and wherein re-configuration of the scalable super-clustered system requires no address re-assignments yet allowing the end nodes in the cluster nodes to maintain connectivity therebetween.

30. A scalable super-clustered system as in claim 29, wherein the node-level NNA is configured to provide support for super-scaled clustering by transforming a local primary-level cluster address into a corresponding upper-level global cluster address for each packet in an outbound path from any of the primary-level clusters and by transforming an upper-level global cluster address into a corresponding local primary-level cluster address for each packet in an inbound path to any of the primary-level clusters.

31. A scalable super-clustered system as in claim 29, wherein the primary-level NNA is configured to provide support for super-scaled clustering by transforming a local cluster address into a corresponding global cluster address for each packet in an outbound path from any of the cluster nodes and by transforming a global cluster address into a corresponding local cluster address for each packet in an inbound path to any of the cluster nodes.

32. A scalable super-clustered system as in claim 29, wherein the NNA is configured with a software algorithm to prevent a duplicate assignment of any address so that, at any point in time, an end node cannot be a member of more than one of the plurality of cluster nodes.

33. A scalable super-clustered system as in claim 29 capable of operating in a TCP-IP (transmission control protocol-Internet protocol) network environment.

34. A scalable clustered system as in claim 1, wherein the NNA is configured with a software algorithm to prevent a duplicate assignment of any address so that, at any point in time, an end node cannot be a member of more than one of the plurality of cluster nodes.

35. A scalable clustered system as in claim 1 capable of operating in a TCP-IP network environment.

36. A scalable clustered system as in claim 28 capable of operating in a TCP-IP (transmission control protocol-internet protocol) network environment.

37. A method as in claim 22 implemented in a TCP-IP (transmission control protocol-internet protocol) network environment.

38. A scalable super-clustered system as in claim 29 further comprising:
higher levels of the hierarchy each of which including a higher-level fabric interconnecting clusters of the level below, each such cluster including a sub-cluster NNA interposed between that cluster and the higher-level fabric to which it is connected.

39. A scalable super-clustered system as in claim 29, wherein the local cluster address is a fixed cluster number of a cluster node, and wherein the global cluster address is a cluster number assigned to the cluster node during cluster configuration.

40. A scalable clustered system as in claim 1, wherein the local cluster address is a fixed cluster number of a cluster node, and wherein the global cluster address is a cluster number assigned to the cluster node during cluster configuration.
